(19) United States
(12) Patent Application Publication
(10) Pub. No.: US 2005/0121843 A1
(43) Pub. Date: Jun. 9, 2005

(54) Pneumatic clamping device

(76) Inventor: Giuseppe Maffeis, Brescia (IT)

Correspondence Address: MCGLEW & TUTTLE, PC, P.O. BOX 9227, SCARBOROUGH STATION, SCARBOROUGH, NY, 10510-9227, US

(21) Appl. No.: 11/036,252

(22) Filed: Jan. 14, 2005

(30) Foreign Application Priority Data
Jan. 28, 2003 (IT) BS2004A000011

(51) Int. Cl. B23Q 3/08

(52) U.S. Cl. 269/32

(57) ABSTRACT

The invention concerns a pneumatic clamping device which comprises a body, a clamping arm (14) supported by a body and turning with respect to the shaft (22) between a rest position, and an operating position, and a pneumatic piston (12) with a stem (13) connected to the clamping arm by means of a toggle joint (15) to control the rotation. The body (11) is essentially a single piece formed from an extruded profile and which forms at the same time a chamber (16) housing the piston, a guide hole (17) for the piston stem and a means of support for the shaft. The body, on a level with the toggle joint, has a part removed and reintegrated completely by an inserted flange (20).

### FIELD OF THE INVENTION

The present invention concerns a pneumatic clamping device for the controlled blocking and releasing of items.

### STATE OF THE TECHNIQUE

There are already well known clamping devices of the type here considered, which include a clamping arm turning with a shaft between an inactive rest, position, and an active, operating position, controlled by a pneumatic cylinder through a toggle joint.

Normally, the clamping arm is sustained by a body associated with the pneumatic cylinder. More precisely, on one side, the body is fundamentally made up of at least two elements or complementary shells, joined together and which support the shaft of the clamping arm and enclose the toggle joint. On the other side, the pneumatic cylinder houses a piston with a stem that extends into the body, where it connects to the toggle joint so that the rotations of the clamping arm correspond to the alternating movements of the piston between the rest and operating positions.

In other words, the pneumatic cylinder represents a structurally autonomous, linear actuator, complete with head flange, both on the side of the piston stem and on the opposite side, as a standard cylinder, whereas the body that supports the turning, clamping arm is in addition made of steel and it is connected and fixed to the cylinder. Furthermore, to maintain its linearity, even under force when the clamping arm is in the operating position, the stem of the piston is fitted with two rollers on opposite sides which rest against and slide, following the stem, on surfaces shaped inside the body.

It is however evident how the realisation and assembly of a pneumatic clamping device according to the known techniques are rather complex and costly, because the components have to be fitted separately in the body holding the turning clamping arm and the toggle joint and then such body must be fitted with a pneumatic cylinder, which is, in itself, not built for this type of fitting and therefore must be adapted.

### OBJECTS AND SUMMARY OF THE INVENTION

Starting from this premise, one of the objects of this invention is to provide a pneumatic clamping device in which one component forms both the chamber, that is the cylinder, housing of the control piston, and the body supporting the toggle joint and controlled clamping arm.

Another object of the invention therefore is to provide a pneumatic clamping device wherein the cylinder for the piston and the body supporting the toggle joint and clamping arm are integrated, namely made out of a single component that, in addition, can be advantageously made starting from an extruded aluminium element or one of its alloys.

In this way, compared to the known technique, the clamping device of the present invention does not require a flange on a level with the cylinder on the side of the piston stem, but simply a closing flange on the opposite side; the piston stem is positively guided in the integral body for most of its length; the body requires a member for completion only as regards to the toggle joint, which, in actual fact can be provided by the extruded element forming the body; the group becomes must simpler to make, more economic and compact even with the use of a cylindrical piston.

Said objects are achieved, according to the invention, with a pneumatic clamping device in accordance with claim 1.

### BRIEF DESCRIPTION OF THE DRAWINGS

This invention will however be described more in detail in the continuation of this description made in reference to the enclosed indicative and not limiting drawings, in which:

FIG. 1 is an exploded view in perspective of the components of the device;

FIG. 2 is a perspective view of only the piston connected to the clamping arm by means of the toggle joint;

FIG. 3 is a perspective view of the device as assembled;

FIG. 4 is a perspective view again of the assembled device, but in a longitudinal cross-section to illustrate the components;

FIG. 5 is a side view of the device with the clamping arm seen in different angles;

FIGS. 6 and 7 are partial cross-section view from front and rear of the device in FIG. 5;

FIG. 8 is a vertical cross-section of the device in the plane of the toggle joint;

FIGS. 9 and 10 are views from above and from below of the device; and

FIGS. 11 and 12 are cross sections of the device respectively on a level with a lateral support roller of the stem and of rotation shaft of the clamping arm.

### DETAILED DESCRIPTION OF THE INVENTION

As shown, the clamping device is indicated globally by 10 and comprises a body 11, a piston 12 with relative piston stem 13, best cylindrical but not necessarily, a clamping arm 14 and a toggle joint 15.

The body 11 is substantially one piece only, made from an extruded profile in aluminium or one of its alloys, therefore with uniform cross-section and having a proximal end or base 11′ and a distal end 11″, the latter possibly rounded off according to needs.

In the body 11 there are provided, in an axial direction from the proximal to the distal ends, a chamber 16 which houses the piston 12 and a hole 17 which houses and guides the piston stem 13 with interposition of seals both on the piston and the stem. At the proximal end of the body, the chamber 16 is closed by a base flange 18 inside which there is a seal plug 18′. Holes can be envisaged on the sides of the body for holding the device in place and for the application of further accessories, including grooves for fitting sensors.

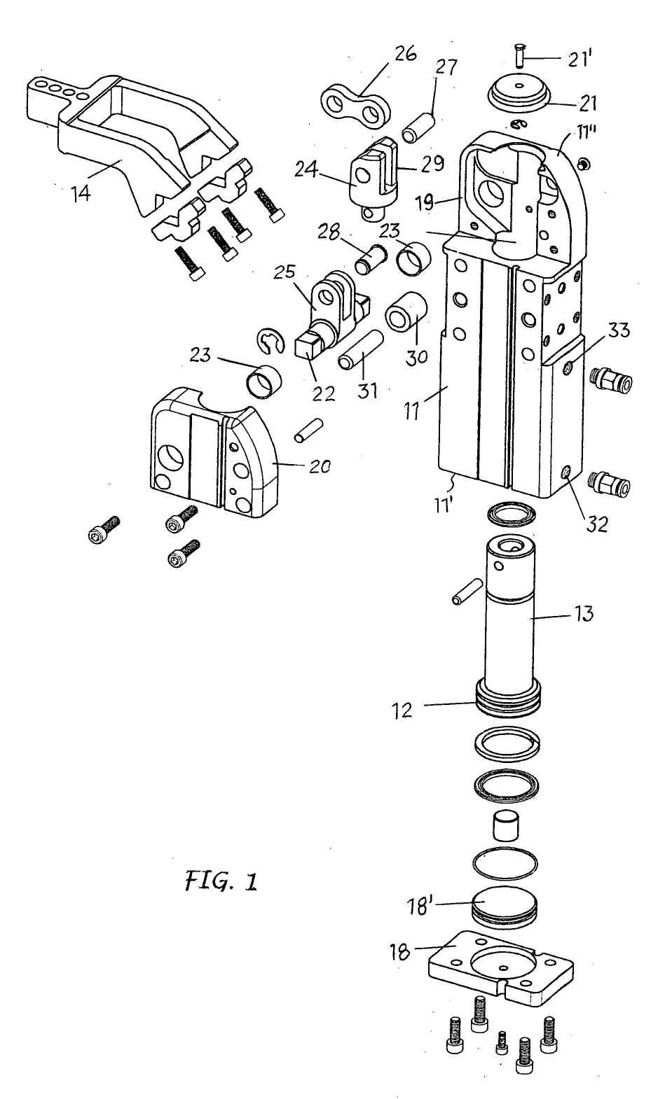

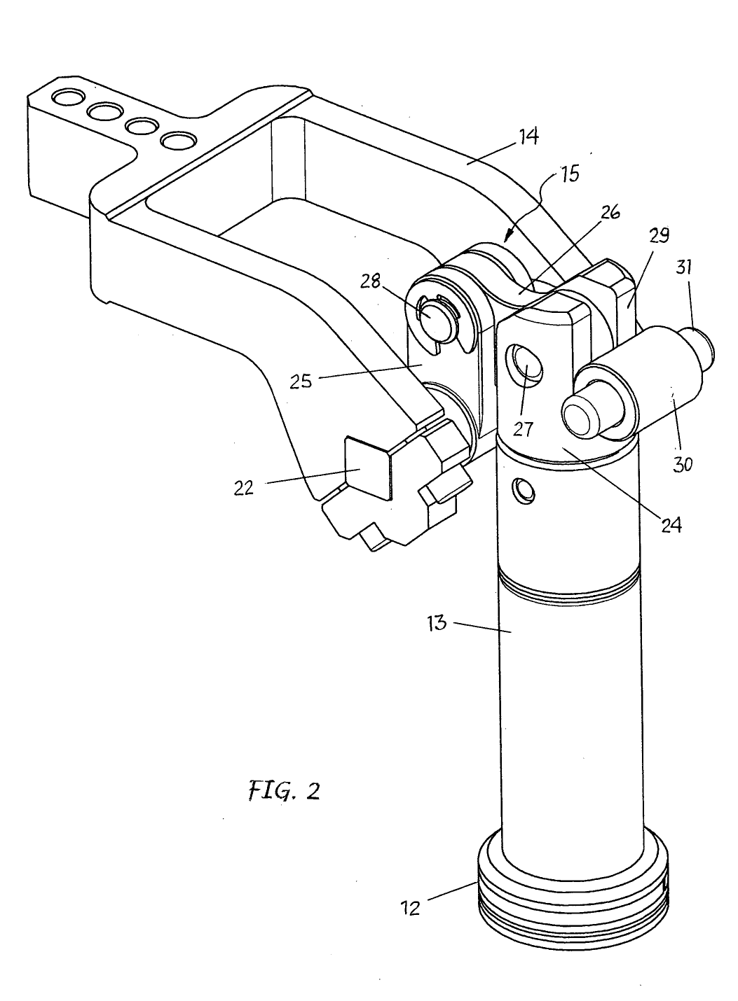

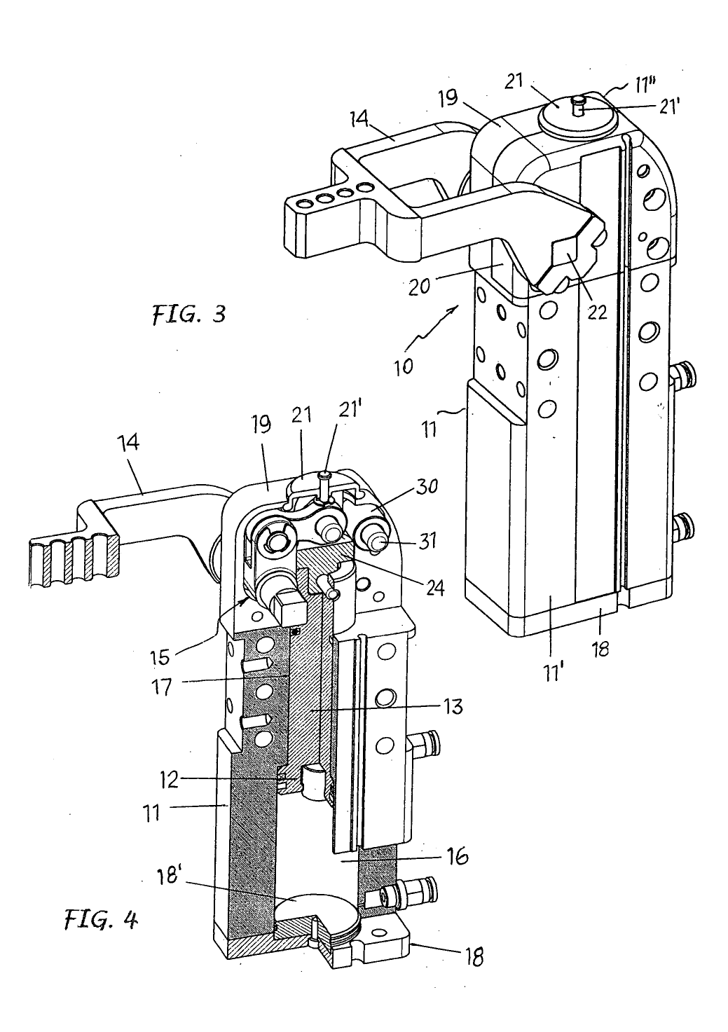

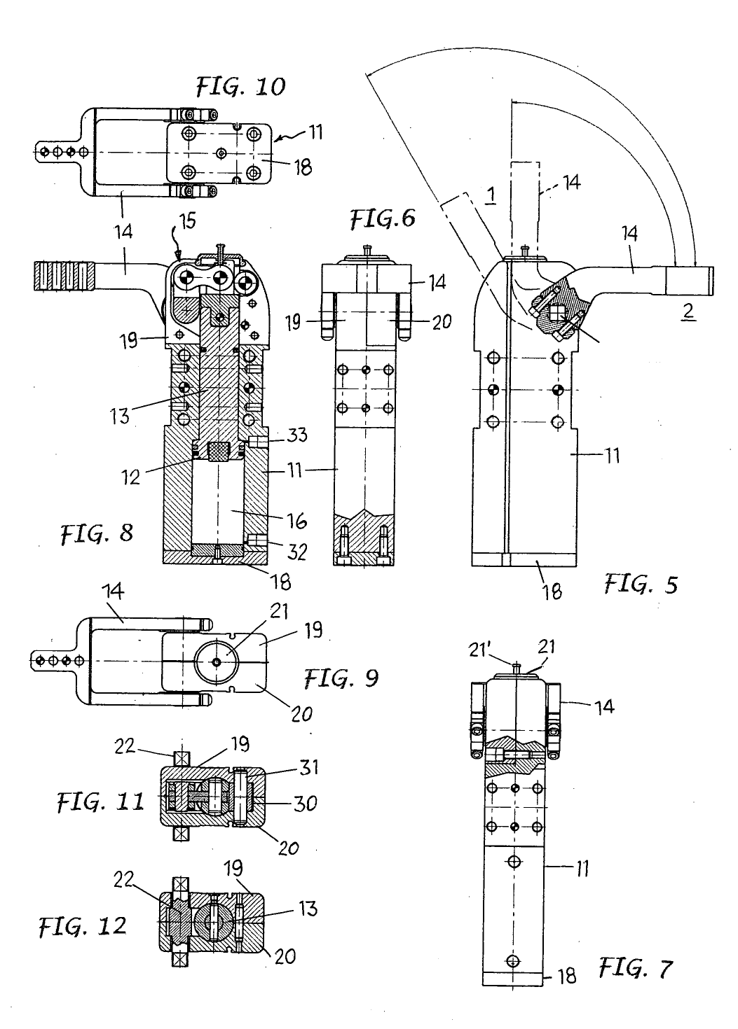

The piston stem 13 extends into the guide hole 17 towards the distal end of the body. Here a portion of the body has been removed to leave room for an integral flange 19, equal to about half the width of the body itself, and the guide hole 17 for the stem 13 open on one side for a part of its length—FIG. 1

An added flange 20 is formed, also made from the extruded profile of said body, and fitted to and facing the flange 19 integral with the body. The added flange 20 is shaped so as to fit complementary to flange 19 so as to integrate the body and completely re-establish the guide hole 17 of stem 13. At the distal end 11″ of the body 11, between the two associated flanges 19, 20 is fitted a cap 21 closing the guide hole 17 for the stem 13.

Together, the two integral and shaped flanges 19,20, support a shaft 22 which turns on bearings or bushings 23, and the ends of which extend from the opposite sides of said flanges.

The clamping arm 14 is shaped like a fork and fixed to the ends of said shaft 22 and turning with the latter through an angle of usually about 90°-120° between an inactive rest position 1 and an active operating position 2—FIG. 5.

The toggle joint 15 is placed between the two associated flanges 19, 20, located between the piston stem 13 and the shaft 22 of the clamping arm 14. More precisely, the toggle joint 15 includes a forked element 24 adapted to and fixed to the free end of the stem 13, a lever 25, also forked, fixed and turning with said shaft 22 and a rigid connecting element 26 which is pivoted on one side, in 27, to the element 24 fixed to the stem 13 and on the other, in 28, to the lever 25 fixed to the shaft 22—FIGS. 2, 4.

On one side of the forked element 24 at the end of the piston stem 13, on the opposite side of the latter to the one adjacent to the shaft 22 of the clamping arm 14, there is a flat area 29 which rests against a locator roller 30, stationary compared to the stem, but rotating on an axis 31 supported between the flanges 19, 20, parallel to said shaft.

The piston 12 is usually double effect and from one side of the chamber 16 that houses it are cut two passages 32, 33 at different levels for the alternative input and output of a fluid under pressure conveniently fed for the movements of the piston in opposite directions.

The rotation of the clamping arm 14 from the inactive position to the active operating position, and the stop of the arm itself in this work position by means of the toggle joint, corresponds to the forward movement of the piston 12, that is towards the distal end of the body 11. To be noted that the locator roller 30, stationary in the body even if it can turn, resting against the lateral slat side 29 of the stem 13, helps to maintain the latter on an axis even when in the block and unblock phases of the toggle joint it finds itself subjected to the maximum crosswise thrust, and the cover 21 at the distal end of the body holds a thrust pin 21′ in case an emergency release of the toggle joint is required if there is a lack of fluid.

1. Pneumatic clamping device, including a body, a clamping arm on board said body and turning with a respective shaft between an inactive rest position, and an active operating position, and a pneumatic piston with a piston stem connected to said clamping arm by means of a toggle joint to control the rotation between said rest and operating positions, characterized in that said body is substantially a single piece and forms at the same time a chamber housing the piston, a guide hole for the stem of the piston and a means of support for the shaft of the clamping arm.

2. Pneumatic clamping device according to claim 1, wherein said body is formed from an extruded aluminum profile with uniform cross-section, wherein the chamber housing the piston and the guide hole of the piston stem extend from a proximal end towards a distal end of said body, and wherein said distal part of the body has a portion has a portion removed leaving an integral flange, equal to roughly half of the width of the body, and opening on one side the guide hole of the piston stem for a part of its length, and wherein an inserted flange, is fixed to said integral flange of the body, to reintegrate the body in its distal part and to re-establish the guide hole of the piston stem.

3. Pneumatic clamping device according to claim 1, wherein the shaft of the clamping arm is supported crosswise by the body integral flange and by the inserted flange, and wherein the toggle joint is placed between said flanges, said toggle joint being connected on one side at the free end of the piston stem and on the other at the shaft of the clamping arm.

4. Pneumatic clamping device according to claim 3, wherein the toggle joint includes a forked element positioned and fixed to the free end of the piston stem, a lever fixed and turning with said shaft of said clamping arm and a rigid connecting element which is pivoted at one point to the element fixed to the piston stem and on the other to the lever fixed to said shaft, and wherein on one side of said forked element a flat area is formed which rests against a locating roller, stationary compared to the piston stem, but turning on an axis supported between the flanges, parallel to said shaft and intended to oppose the transversal thrusts the piston stem is subjected to.

5. Pneumatic clamping device according to claim 2, wherein a base flange is fixed to the proximal part of said body in one single piece and has a sealing plug to close the chamber housing the piston, wherein at the distal part of said body a closing cover is fixed between said integral and inserted flanges to close said hole housing the piston stem, said cover holding a pin for releasing the toggle joint, and wherein along at least one side of said body at least one groove is provide for application of accessories.

6. Pneumatic clamping device according to claim 2, wherein the shaft of the clamping arm is supported crosswise by the body integral flange and by the inserted flange, and wherein the toggle joint is placed between said flanges, said toggle joint being connected on one side at the free end of the piston stem and on the other at the shaft of the clamping arm.
